(19) United States
(12) Patent Application Publication
(10) Pub. No.: US 2009/0164799 A1
(43) Pub. Date: Jun. 25, 2009

(54) IC CARD IN WHICH BIOMETRIC INFORMATION IS STORED AND METHOD OF CONTROLLING ACCESS TO THE IC CARD

(76) Inventor: Nobuya TAKAGI, Osaka (JP)

Correspondence Address: MCDERMOTT WILL & EMERY LLP, 600 13TH STREET, NW, WASHINGTON, DC, 20005-3096, US

(21) Appl. No.: 12/338,457

(22) Filed: Dec. 18, 2008

(30) Foreign Application Priority Data
Dec. 20, 2007 (JP) 2007-328622

(51) Int. Cl. H04K 1/00; H04L 9/00

(52) U.S. Cl. 713/186

(57) ABSTRACT

Biometric information previously obtained from an IC card bearer and security status for determining whether or not the IC card is accessible are stored in the IC card. Then, a biometric authentication device obtains biometric information from the IC card bearer and reads the previously-obtained biometric information from the IC card. The biometric authentication device compares the biometric information with the previously-obtained biometric information and transmits a result of the comparison to the IC card. The IC card verifies the comparison result transmitted thereto and determines whether or not the comparison result was illegally fabricated or altered, and updates the security status when it is determined that the comparison result was neither fabricated nor altered.

### BACKGROUND OF THE INVENTION

1. Field of the Invention

The present invention relates to an IC card in which biometric information is stored and a method of controlling access to the IC card.

2. Description of the Related Art

In recent years, the widespread use of an IC card is increasingly seen in various fields relating to transportation, finance, passports, drivers' licenses and the like. The IC card comprises anon-volatile memory, in which a file, a personal identification number of a cardbearer and the like can be stored. One of basic features of the IC card is to independently verify the personal identification number within the card. The feature of the verification of the personal identification number within the card is realized as described below.

First, the personal identification number stored in the non-volatile memory of the IC card is compared with a personal identification number inputted from the outside, and a result of the comparison is retained in the volatile memory of the IC card. This piece of information is called security status. There are other pieces of information written in the file of the IC card as attribute information. In the case where only the IC card bearer is authorized to read the file, for example, information indicating that it is necessary to verify the personal identification number of the IC card bearer before the file is demanded. This piece of information is called a security attribute, and the security attribute is written in the file of the IC card as the attribute information.

In the case of the IC card in which the security attribute is previously written, the IC card bearer is authorized to read the file only when the security status described earlier satisfies conditions indicated by the security attribute. When the personal identification number is thus verified within the IC card so that the IC card can independently determine if the file can be accessed, a high level of security can be assured.

On the other hand, as recited in No. 2000-215279 of the Japanese Patent Applications Laid-Open, a system which carries out biometric authentication using fingerprints, facial images and the like is devised in order to improve the safety and user-friendliness in the authentication of the card bearer, and will soon be put into practical use.

### SUMMARY OF THE INVENTION

Therefore, a main object of the present invention is to provide an access control method used between an IC card flexibly adaptable to the biometric authentication currently commercialized and a biometric authentication device.

In order to achieve the foregoing object, an access control method according to the present invention is an access control method used between an IC card and a biometric authentication device, comprising:

a first step in which previously-obtained biometric information previously obtained from a bearer of the IC card and security status for determining whether or not the IC card is accessible are stored in the IC card;

a second step in which the biometric authentication device obtains the IC card bearer's biometric information from the IC card bearer and reads the previously-obtained biometric information from the IC card;

a third step in which the biometric authentication device compares the biometric information with the previously-obtained biometric information and transmits a result of the comparison to the IC card; and

a fourth step in which the IC card verifies the transmitted comparison result and determines whether or not the comparison result is illegally fabricated or altered, and updates the security status in the case where it is determined that the comparison result is neither fabricated nor altered.

According to the present invention thus constituted, the following effect can be obtained. In the conventional constitution, it is not practical to verify biometric information within the IC card, as is the case with a personal identification number, in view of a processing time or for other reasons. Therefore, the biometric information is conventionally verified outside the card. Further, the verification of the biometric information is currently adopted only in some particular systems which are required to achieve a high security level since an exclusive device provided with a sensor and the like is necessary as an external device. As the IC card will be used in a broader extent in the future, however, it is desirable that the biometric authentication and the authentication based on the personal identification number be both realized, for example, the biometric authentication is adopted in any system where the biometric authentication device is provided, while the IC card bearer is authenticated based on the personal identification number in other systems. However, the input of the personal identification number is still necessary after the biometric authentication is performed in the conventional technology, which is disadvantageously less user-friendly.

The disadvantage is specifically described below. The read of the file cannot be authorized by the biometric authentication alone because the biometric authentication is performed outside the IC card, and the comparison result thereby obtained, therefore, is not reflected in the security status within the IC card. In other words, it becomes necessary to verify the personal identification number in order to satisfy the security attribute of the file, and the IC card bearer is still requested to input the personal identification number after his/her identify has been verified as a result of the biometric authentication, which makes the system less user-friendly. According to the present invention, since the biometric authentication result in the biometric authentication device can be reflected in the security status within the IC card while the safety is guaranteed at the same time, the biometric authentication result obtained outside can be used for the access control in a manner similar to the comparison result within the card based on the personal identification number. As a result, when the biometric authentication is completed, it becomes unnecessary to input the personal identification number, and a user-friendly system can be built.

As another mode of the present invention, an intermediate value indicating a degree of the likelihood that the IC card bearer is authentic is generated based on the comparison of the biometric information with the previously-obtained biometric information, and the intermediate value is compared to a threshold value which can be arbitrarily set depending on an extent of access restriction so as to generate the comparison result in the third step.

According to the mode thus constituted, an effect described later can be obtained. The relationship between the biometric authentication and the user-friendliness is described before the description of the effect. There is a trade-off relationship between the safety (inauthentic bearer acceptance ratio) and the user-friendliness (authentic bearer denial ratio) peculiar to the biometric authentication. In the biometric authentication in which the IC card is used, the biometric information stored in the IC card is compared with the biometric information of the IC card bearer so as to verify the card bearer, and the determination value (threshold value) based on the similarity of these pieces of information is set. Accordingly, the safety and the user-friendliness suitable for the system can be set. However, the inauthentic bearer acceptance ratio is increased when the authentic bearer denial ratio is controlled to a low level, while the authentic bearer denial ratio is increased when the inauthentic bearer acceptance ratio is controlled to a low level. It is desirable that the IC card system wherein the biometric authentication is performed flexibly respond to this characteristic.

The constitution according to the mode described above can flexibly respond to the trade-off relationship generated in the IC card system wherein the biometric authentication is performed.

More specifically, the comparison result is not limited to such binary information as “verified” and “not verified”, and information of a gray zone therebetween can also be transmitted as the comparison result. Thus constituted, a permissible access extent can be limited depending on the degree of the likelihood that the IC card bearer is authentic. As a result, the system capable of flexibly responding to the characteristics of the biometric authentication can be built.

As so far described, the method according to the present invention is useful for an IC card system wherein a personal identification number and biometric authentication are adopted.

### BRIEF DESCRIPTION OF THE DRAWINGS

These and other objects of the invention will become clear by the following description of preferred embodiments of the invention and be specified in the claims attached hereto. A number of benefits not recited in this specification will come to the attention of the skilled in the art upon the implementation of the present invention.

FIG. 1 is a block diagram illustrating a constitution of an IC card according to a preferred embodiment 1 of the present invention.

FIG. 2 illustrates verification steps based on a personal identification number according to the preferred embodiment 1.

FIG. 3 is an illustration of security status according to the preferred embodiment 1.

FIG. 4 is an illustration of a security attribute according to the preferred embodiment 1.

FIG. 5 illustrates verification steps based on biometric authentication according to the preferred embodiment 1.

FIG. 6 is an illustration of a security status update command according to the preferred embodiment 1.

FIG. 7 is an illustration of a security condition according to the preferred embodiment 1.

FIG. 8 is an illustration of a security condition according to a preferred embodiment 2 of the present invention.

FIG. 9 is an illustration of biometric information according to a preferred embodiment 3 of the present invention.

FIG. 10 illustrates verification steps based on biometric authentication according to a preferred embodiment 4 of the present invention.

### DETAILED DESCRIPTION OF THE INVENTION

Hereinafter, preferred embodiments of according to the present invention are described in detail referring to the drawings.

### Preferred Embodiment 1

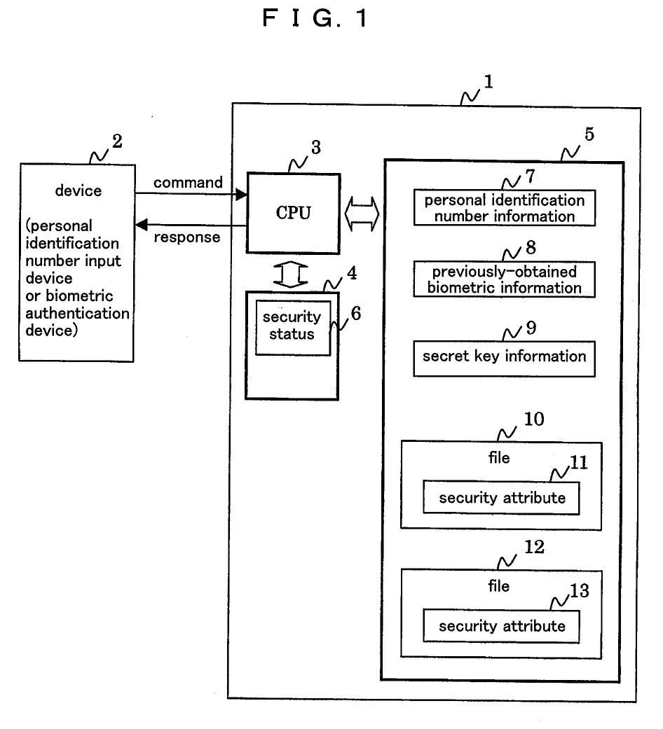

FIG. 1 is a block diagram illustrating a constitution of an IC card to which an access control method according to a preferred embodiment 1 of the present invention is applied. In FIG. 1, 1 denotes an IC card, 2 denotes a device for authenticating a bearer of the IC card 1. An example of the device 2 is a biometric authentication device, and a personal identification number input device may be the device 2 in some systems. The IC card 1 comprises a CPU 3, a RAM 4 and an EEPROM 5. The CPU 3 is in charge of all of the processing of the IC card 1 including transmission and reception of commands and responses between the IC card 1 and the device 2 and access control. The RAM 4 is a volatile memory used for an operation, in which a security status 6 is stored in sequence. The EEPROM 5 is a non-volatile memory in which personal identification number information 7 previously set by the IC card bearer, previously-obtained biometric information 8 previously obtained from the IC card bearer, secret key information 9, various security files 10 and 12, and the like are stored. The CPU 3 serves as a transmitter, a receiver and an update unit.

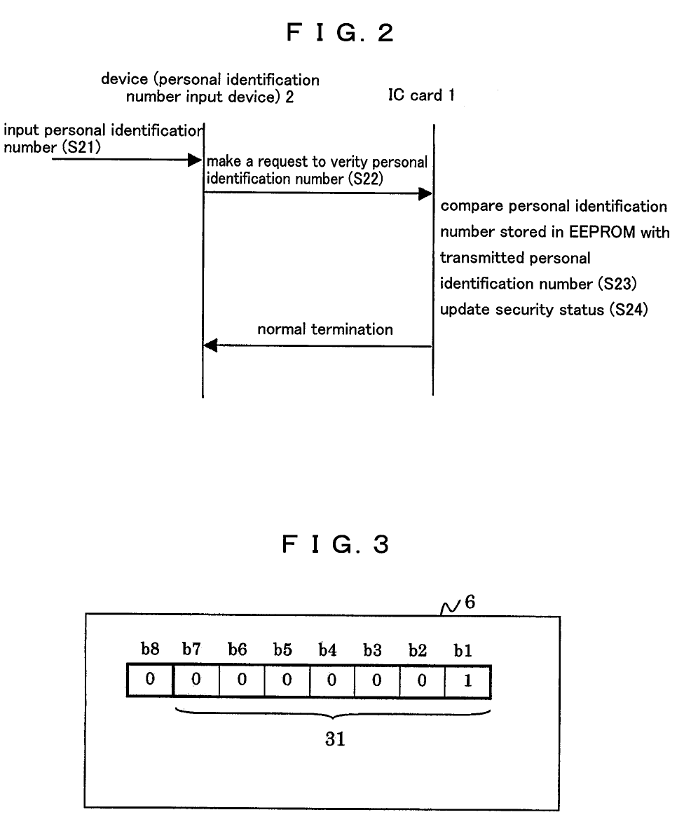

FIG. 2 illustrates steps of verifying the personal identification number in the case where authentication is performed based on the personal identification number and an application in which the IC card 1 is used is utilized. In this system, the device 2 illustrated in FIG. 1 is the personal identification number input device. The personal identification number input device 2 comprises an input unit (not shown) in which a key pad is used, and the IC card bearer inputs his/her personal identification number via the input unit (Step S21). In response to this, the personal identification number input device 2 transmits the inputted personal identification number input information and a personal identification number verification request to the IC card 1 (Step S22). The IC card 1 receives the request, compares the transmitted personal identification number input information with the personal identification number information 7 stored in the EEPROM 5 (Step S23). In the case where the inputted personal identification number is correct according to the result of the comparison in the Step S23, the security status 6 in the RAM 4 is updated (Step S24) as a proof that the personal identification number input information is compared and found correct. As illustrated in FIG. 3, eight bits constitute the security status 6. Of the eight bits, the most significant bit (b8) is not used, and verification information 31 corresponding to the less significant seven bits (b1-b7) is used. The bits of the verification information 31 each correspond to a key (personal identification number, device authentication key, or the like). In the present preferred embodiment, the least significant bit (b1) corresponds to the personal identification number of the IC card bearer. In the case where the inputted personal identification number is judged to be correct, “1” is set in the bit (b1). The respective bits in the security status 6 correspond to fields recited in the Scope of Claims.

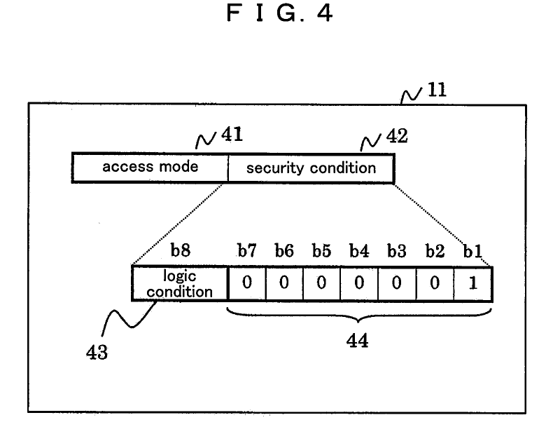

A security attribute of a file stored in the IC card 1 has a structure illustrated in FIG. 4. The description of FIG. 4 is based on a security attribute 11 of a file 10; however, a security attribute 13 of a file 12 has a similar structure. An access mode 41 and a security condition 42 constitute the security attribute 11. The information for identifying a type of access (for example, reading function) with respect to the file is stored in the access mode 41. The information relating to a key to be checked prior to the execution of the function designated in the access mode 41 is stored in the security condition 42. Eight bits constitute the security condition 42, and the bits (b1-b7) of a key condition 44, which are the less significant seven bits, respectively correspond to the bits (b1-b7) of the verification information 31 of the security status 6. More specifically, in the case where it is necessary to verify the personal identification number information in order to read the file 10, “1” is set in the least significant bit (b1) of the key condition, and the CPU 3 of the IC card 1 compares the key condition 44 with the verification information 31 when the file 10 is read out, and authorizes the read of the file 10 only in the case where the contents of the verification information 31 satisfy the conditions shown in the key condition 44.

A logic condition 43, which corresponds to the most significant bit (b8) of the security condition 42, plays its role in the case where “1” is set in a plurality of bits of the key condition 44. The logic condition 43 is used for distinguishing between a state where all of the plurality of keys have to be checked (AND logic) and a state where only any one of the plurality of keys should be checked (OR logic). The description of FIG. 4 was given referring to the reading function; however, any function other than the reading function such as a writing function, is similarly handled. The security condition 42 has as many pieces of information having the same structure as the number of the provided functions.

The security status 6 is the information inside the RAM 4 (volatile memory). Therefore, the information is lost when power supply to the IC card 1 is cut off. Furthermore, when power is supplied to the IC card 4, the CPU 3 of the IC card 1 clears the security status 6. Therefore, the IC card bearer has to input the personal identification number again when he/she thereafter uses the IC card 1.

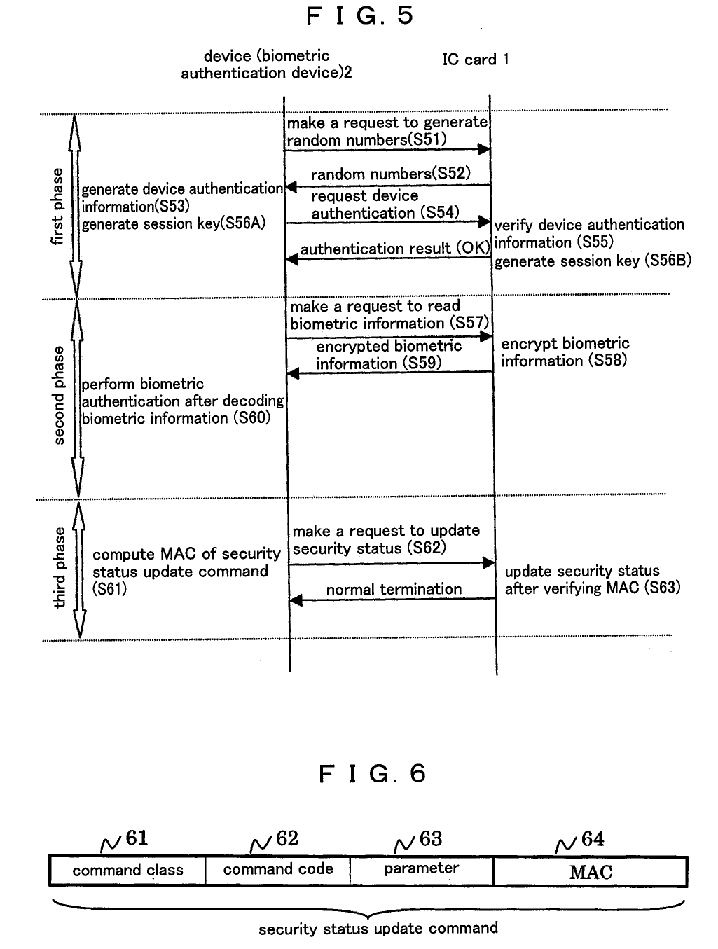

FIG. 5 illustrates processing steps of biometric authentication in the case where the IC card bearer is verified based on the biometric authentication and an application in which the IC card 1 is used is utilized. In this system, the device 2 is a biometric authentication device.

As a first phase, the biometric authentication device 2 is authenticated by the IC card 1. The biometric authentication device 2 requests the IC card 1 to generate random numbers (Step S51). Then, the IC card 1 generates random numbers and transmits them to the biometric authentication device 2 (Step S52). The biometric authentication device 2 encrypts the random numbers using the secret key information which was previously obtained and recorded, and thereby generates device authentication information and transmit it to the IC card 1. This is a device authentication request made to the IC card 1 (Steps S53 and S54). In the EEPROM 5 of the IC card 5, secret key information 9 which is the same as the secret key information of the biometric authentication device 2 is stored, and the encrypted device authentication information is decoded by the secret key information 9. A decoding result thereby obtained is compared with the random numbers generated by the IC card 1 itself for the purpose of authentication (Step S55). In the case where they are identical to each other as a result of the comparison, it is judged that the device authentication information is encrypted with the authorized secret key, and the biometric authentication device 2 is an authorized one. At the time, the biometric authentication device 2 and the IC card 1 generate two sets of session keys and share them (Step S56A, S56B: these keys are called a first session key and a second session key in the description below).

The session keys are generated, for example, when a particular computing operation is implemented to the secret key and the random numbers described earlier. When a parameter for discriminating between the first and second session keys is inputted in the computing operation, the two sets of session keys can be generated. The biometric authentication device 2 and the IC card 1 thus execute the same computing operation and can thereby share the same session keys.

As a second phase, the biometric authentication device 2 reads the previously-obtained biometric information 8 stored in the EEPROM 5 of the IC card 1 (Steps s57, S58 and S59). At the time, the biometric information 8 is encrypted by the first session key generated in the first phase and thereafter transmitted. The biometric authentication device 2 decodes the previously-obtained biometric information 8 based on the same session key, and performs the biometric authentication (Step S60). More specifically, the biometric authentication device 2 obtains biometric information from the IC card bearer and extracts characteristics therefrom, and thereafter compares the extracted characteristics of the biometric information with the previously-obtained biometric information 8 read from the IC card 1. A result of the comparison is converted into a numeral which shows a level of the similarity between the two pieces of information. The comparison result (the level of similarity) is further compared with a threshold value previously set in the present system. Then, the current IC card bearer is identified as an authentic bearer when the comparison result (the level of similarity) is higher than the threshold value. The threshold value is data by which to judge with a certain level of certainty whether the IC card bearer is authentic, and is variously set depending on an extent of access restriction.

As a third phase, the security status 6 of the IC card 1 is updated (Steps S61, S62 and S63). This processing starts when a security status update command illustrated in FIG. 6 is transmitted from the biometric authentication device 2 to the IC card 1 (processing of Step S61). In the security status update command, a command class 61 denotes a security level of a command, which indicates that the command is protected by a MAC 64 as described later. A command code 62 is used to identify the command as a security status update command. A parameter 63 shows a bit number of the security status 6 to be updated. In the present preferred embodiment, information indicating the least significant bit (b1), which is the same as the allocated bit for the personal identification number, is set. The MAC 64 is a message authentication code for preventing the fabrication of the security status update command.

More specifically, the biometric authentication device 2 and the IC card 1 combine the command class 61, command code 62 and parameter 63, and encrypt the combined body thus obtained using the second session key and thereafter compress it into eight bytes so as to generate the MAC 64.

The IC card 1, upon the reception of the security status update command, generates a MAC using the same session key, and determines that the received command is not an illegally fabricated command when the generated MAC is the same as the received MAC 64. When it is confirmed that the command is not a fabricated one, the IC card 1 determines that the biometric authentication in the device 2 (biometric authentication device) was properly performed, and sets “1” in the least significant bit (b1) of the security status 6 designated by the parameter 63 (Step S63).

Thus, in the case where the biometric authentication is performed in the device (biometric authentication device) 2, the least significant bit (b1) of the security status 6 is set as in the case of the verification of the personal identification number within the IC card 1. Therefore, the file 10 can be thereafter read. In other words, the performance of biometric authentication makes it unnecessary to input the personal identification number, which improves the user-friendliness for the IC card bearer. Further, the security can be guaranteed because the security status update command can only be generated in the biometric authentication device 2 which was authorized in the device authentication in the first phase.

In the example described earlier, the biometric authentication and the verification of the personal identification number have the same extent of impact relating to the access control with respect to the files 10 and 12. However, the biometric authentication is a more reliable means for the authentication of the IC card bearer than the verification of the personal identification number. Therefore, the system can have more flexibility in the case where functions which can be executed after the biometric authentication and functions which can be executed after the verification of the personal identification number can be separately set. This can be realized when different bits are allocated in the verification information 31 and the key condition 44 respectively in the biometric authentication and the verification of the personal identification number.

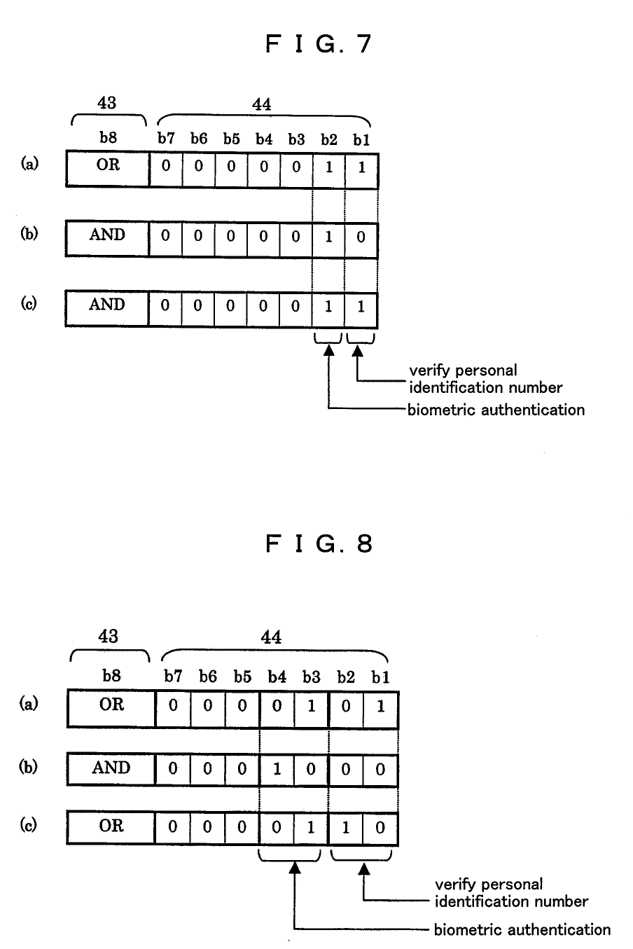

Below is described a method in which the file 10 can be read after the biometric authentication or the verification of the personal identification number and the file 12 can be read only after the biometric authentication referring to FIG. 7. In order to realize the method, b1 is allocated for the verification of the personal identification number and b2 is allocated for the biometric authentication with regard to the verification information 31 and the key condition 44. Then, when the logic condition 43 is set to an OR condition as illustrated in FIG. 7a) as the security condition of the file 10, the read of the file 10 is authorized after the biometric authentication or the verification of the personal identification number.

Alternatively, when the logic condition 43 is set to an AND condition, “1” is set in b2 corresponding to the biometric authentication, and “0” is set in b1 corresponding to the verification of the personal identification number as illustrated in FIG. 7b) as the security condition of the file 12, the read of the file 12 is not authorized after the verification of the personal identification number, and can only be authorized after the biometric authentication. In this case, the number of bits in which “1” is set is only one bit; therefore, the logic condition 43 can be set to either the AND logic or OR logic.

When the logic condition 43 is set to the AND condition, “1” is set in b2 corresponding to the biometric authentication, and “1” is set in b1 corresponding to the verification of the personal identification number as illustrated in FIG. 7c), the verification of the personal identification number and the biometric authentication are both necessary, and an access right which is more solid and firm can be set.

### Preferred Embodiment 2

In the preferred embodiment 1, only binary verification information, namely, whether or not the identity of IC card bearer was verified, is supplied as the verification result transmitted from the biometric authentication device 2 to the IC card 2. However, the extracted characteristic data actually varies depending on environmental conditions such as humidity and temperature, and therefore, cannot be completely identical to the data read from the IC card 1. Therefore, a level of the similarity between the biometric information directly obtained from the IC card bearer by the biometric authentication device 2 and the previously-obtained biometric information 8 read from the IC card 1 is compared to a predetermined threshold value so as to determine if the IC card bearer is authentic or inauthentic. As a result, an inauthentic bearer acceptance ratio is increased when an authentic bearer denial ratio is controlled to a low level, while the authentic bearer denial ratio is increased when the inauthentic bearer acceptance ratio is controlled to a low level. In other words, the obtained result may be overturned depending on the set threshold value.

In view of the biometric authentication thus characterized, it is practically advantageous to limit the extent of executable functions depending on the degree of the likelihood that a bearer is authentic. For example, in the case where the IC card bearer is likely to be authentic at an ordinary level, functions except particular functions are caused to be executable, and particular functions may be used only when a high accuracy of authentication is required. This can be realized when a plurality of bits are allocated for the biometric authentication in the verification information 31 and the key condition 44.

Below is given an example where the data stored in the file 10 is ordinary personal data, and the data stored in the file 12 is personal data which is highly confidential. More specifically, the file 10 can be read after the verification of the personal identification number or the biometric authentication at an ordinary level, while the file 12 can be read only after the biometric authentication at a high level. In order to realize it, two bits of b3 and b4 are allocated for the biometric authentication in the verification information 31 and the key condition 44. In the case where “1” is set in b3 in the key condition 44, the ordinary-level biometric authentication is necessary in order to read the file. In the case where “1” is set in b4 in the key condition 44, the high-level biometric authentication is necessary in order to read the file. Two bits of b1 and b2 are similarly allocated for the verification of the personal identification number for the sake of convenience; however, b2 is not used because only one bit is enough to show whether the verification of the personal identification number is necessary.

The biometric authentication device 2 sets a high and low threshold values, and determines that the ordinary-level biometric authentication is successful in the case where a consistency ratio of the characteristic data of the biometric authentication is between the two threshold values, and the high-level biometric authentication is successful in the case where the consistency ratio exceeds the high threshold value. In the case where the consistency ratio falls below the low threshold value, it is determined that the biometric authentication fails. The security status update command transmitted from the biometric authentication device 2 is constituted as illustrated in FIG. 6 just as is the case with the preferred embodiment 1; however, information by which the level of the comparison result in the biometric authentication described earlier can be identified is set in the parameter 63.

As a simplified example, in a manner similar to the bit allocation in the key condition 44, the ordinary-level biometric authentication is deemed successful when the value of the parameter 63 shows “00000100” (binary numeral), while the high-level biometric authentication is deemed successful when the value of the parameter 63 shows “00001000” (binary numeral).

FIG. 8a) illustrates the security condition of the file 10. In the present preferred embodiment, the logic condition 43 denotes not the logic condition between two bits of the bits of b1-b7 but the logic condition (AND Logic or OR logic) between the condition relating to the verification of the personal identification number (b1 and b2) and the condition relating to the biometric authentication (b3 and b4). In other words, in the case of the OR logic, what is necessary is just to satisfy either the condition relating to the verification of the personal identification number or the condition relating to the biometric authentication. In FIG. 8a), b8 denotes the OR logic, and “1” is set in b3 and b1. Therefore, the file 10 can read after the ordinary-level biometric authentication or the verification of the personal identification number.

On the other hand, the security condition of the file 12 is set as illustrated in FIG. 8b). In the drawing, “1” is set in b4 alone; therefore, the file 12 can be read only after the high-level biometric authentication, and cannot be read after the ordinary-level biometric authentication.

Thus, the information by which the level of the verification result in the biometric authentication can be identified is set in the parameters of the security status update command transmitted from the biometric authentication device 2, and the plurality of bits are allocated for the biometric authentication as the key condition. As a result, the extent of authorized accesses can be limited depending on the degree of the likelihood that the IC card bearer is authentic, and a system capable of flexibly responding to the characteristics of the biometric authentication can be built.

In the foregoing example, b2 for the verification of the personal identification number is not used. When b2 is used, however, the verification of the personal identification number can also be performed on an ordinary-level or high-level basis as in the case of the biometric authentication. For example, the different number of digits can be used for the personal identification number. A possible example is that the access right can be obtained by the verification of a four-digit personal identification number in the case where “1” is set in b1 of the key condition 44, while the access right can be obtained by the verification of an eight-or-more-digit personal identification number in the case where “1” is set in b2. FIG. 8c) illustrates an example where a different level of verification can be made based on the different number of digits described earlier. In this example, the file can be read after the ordinary-level biometric authentication or the verification of an eight-or-more-digit personal identification number.

In the description of the foregoing example, the access conditions are changed on a file-by-file basis. The access conditions may be changed on a function-by-function basis (for example, reading and writing). As described earlier, the combinations of the access mode 41 and the security condition 42 in one file are as many as the number of the functions. Therefore, when different conditions are respectively set in the security condition 42 in the access mode 41 denoting the reading function and the security condition 42 in the access mode 41 denoting the writing function, access conditions for the reading and writing can be made different from each other.

### Preferred Embodiment 3

In the preferred embodiments 1 and 2 was described the method of denoting the bit number of the security status 6 to be updated using the parameter 63 of the security status update command. However, since the biometric authentication device 2 is operable by any bit according to the preferred embodiments 1 and 2, any irrelevant bit can also be changed (for example, b5-7 in the preferred embodiment 2). These bits are sometimes allocated to devices other than the biometric authentication device 2, and in that case, the biometric authentication device 2 is generally not authorized to operate these devices. Therefore, it is not preferable from a security viewpoint that the biometric authentication device 2 can operate these bits without any restriction.

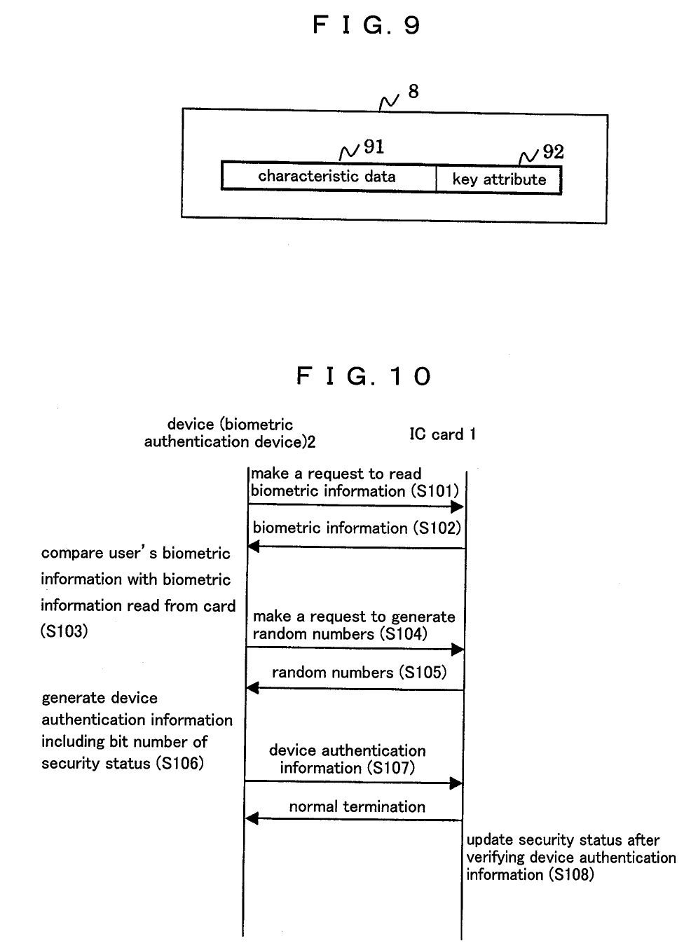

In order to deal with the problem, according to the preferred embodiment 3, the previously-obtained biometric information 8, as a storage unit, has a structure illustrated in FIG. 9. In FIG. 9, characteristic data 91 is a body (characteristic data) of the previously-obtained biometric information 8, and a key attribute 92 is information associated with the previously-obtained biometric information 8, and denotes the bit number of the security status 6.

Below is described a method of further improving the security in the constitution according to the preferred embodiment 1. In the parameter 63 of the security status update command, information only indicating that the biometric authentication was successful (may be a fixed value) is set. Then, after it is confirmed that the security status update command was neither fabricated nor altered, the security status 6 is changed as is the case with the preferred embodiment 1. At the time, the key attribute 92 of the previously-obtained biometric information 8 is referenced. Of the plurality of bits of the security status 6, “1” is set in a bit corresponding to a number set in the key attribute 92.

Next is described a method of improving the security in the constitution according to the preferred embodiment 2. In the parameter 63 of the security status update command, information indicating the level of the biometric authentication is set. For example, the case where “1” is set indicates that the ordinary-level biometric authentication was performed, while the case where “2” is set indicates that the high-level biometric authentication was performed. The key attribute 92 has two pieces of information which are a bit number “3” corresponding to the ordinary level and a bit number “4” corresponding to the high level, and “1” is set in the corresponding bit of the security status 6 in accordance with the level of the biometric authentication indicated by the parameter 63 of the security status update command.

Thus, the bit number of the security status 6 operated by the execution of the security status update command is not given by the command, but is decided by the IC card 1 itself. Therefore, it becomes impossible for the biometric authentication device 2 to operate any bit which the biometric authentication device 2 is not authorized to operate, which improves the security.

The methods for improving the security are not limited to those described earlier, and various different methods can be considered. For example, a threshold value at which the biometric authentication was successful is directly set in the parameter 63 of the security status update command, and any bit to be operated is decided by the IC card 1 based on the threshold value.

### Preferred Embodiment 4

In the description of the preferred embodiments so far, the processing steps are executed in three phases illustrated in FIG. 5. However, the same object can be achieved in a fewer number of steps in the case where it is unnecessary to encrypt and transmit the biometric information. Below is described such a case referring to FIG. 10.

First, in response to a request from the biometric authentication device 2 (Step S101), the IC card 1 transmits the previously-obtained biometric information 8 stored therein (Step S102). The biometric authentication device 2 compares the biometric information directly obtained from the IC card bearer with the previously-obtained biometric information 8 read from the IC card 1 (Step S103). In the case where the identity of the IC card bearer is confirmed as a result of the comparison in the Step S103, the biometric authentication device 2 requests the IC card 1 to generate random numbers (Step S104), and the IC card 1 generates the random numbers in response to the request and transmits the generated random numbers to the biometric authentication device 2 (Step S105). After that, the biometric authentication device 2 encrypts the combination of the random numbers obtained from the IC card 1 and the bit number of the security status 6 to be updated using the secret key so as to generate the device authentication information, and transmits the generated information to the IC card 1 (Steps S106, S107). The IC card 1 decodes the transmitted device authentication information using the same secret key as that of the IC card. When the decoded information includes numbers identical to random numbers generated by the IC card 1, the IC card 1 updates the security status (Step S108) based on the determination that the biometric authentication device 2 is authentic, and the bit number is reliable. The processing steps thereafter are the same as those described so far in the previous preferred embodiments.

According to the processing steps, the authentication of the biometric authentication device 2 and the instruction of updating the security status are realized at the same time. Therefore, a total processing volume and a total transmission volume can be reduced.

In the description of the preferred embodiment 4, the bit number of the security status 6 to be updated are combined with the random numbers. However, it is needless to say that the same object can be achieved when the information only indicating that the biometric authentication was successful or the information indicating the level of the successful biometric authentication are combined with the random numbers, as is the case with the preferred embodiment 3.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. An access control method used between an IC card and a biometric authentication device, comprising:
a first step in which previously-obtained biometric information previously obtained from a bearer of the IC card and security status for determining whether or not the IC card is accessible are stored in the IC card;
a second step in which the biometric authentication device obtains the IC card bearer's biometric information from the IC card bearer and reads the previously-obtained biometric information from the IC card;
a third step in which the biometric authentication device compares the biometric information with the previously-obtained biometric information and transmits a result of the comparison to the IC card; and
a fourth step in which the IC card verifies the transmitted comparison result and determines whether or not the comparison result is illegally fabricated or altered, and updates the security status in the case where it is determined that the comparison result was neither fabricated nor altered.

2. The access control method as claimed in claim 1, wherein
encrypted information obtained when the comparison result is encrypted is transmitted to the IC card in the third step, and
the IC card decodes and verifies the transmitted encrypted information to thereby determine whether or not the encrypted information is illegally altered or fabricated in the fourth step.

3. The access control method as claimed in claim 1, wherein
a personal identification number input device comprising an input unit for receiving a personal identification number inputted by a bearer of the IC card is further prepared,
a fifth step and a sixth step are further included subsequent to the fourth step,
personal identification number information previously set by the IC card bearer is stored in the IC card in the first step,
the personal identification number input device transmits the personal identification number input information inputted to the input unit by the IC card bearer to the IC card in the fifth step, and
the IC card compares the personal identification number input information with the personal identification number information in the sixth step.

4. The access control method as claimed in claim 3, wherein
security status including a first field updated based on the comparison result between the biometric information and the previously-obtained biometric information and a second field updated based on the comparison result between the personal identification number input information and the personal identification number information is stored in the IC card as the security status in the first step,
the first field is updated when it is determined that the comparison result between the biometric information and the previously-obtained biometric information is neither altered nor fabricated in the fourth step, and
the second field is updated when it is determined that the comparison result between the personal identification number input information and the personal identification number information is correct in the sixth step.

5. The access control method as claimed in claim 1, wherein
information including attribute information is stored as the previously-obtained biometric information and security status including a plurality of fields is stored as the security status in the IC card in the first step, and
the IC card selects the field of the security status to be updated based on the attribute information in the fourth step.

6. The access control method as claimed in claim 1, wherein
an intermediate value indicating a degree of the likelihood that the IC card bearer is authentic is generated based on the comparison of the biometric information with the previously-obtained biometric information, and the intermediate value is compared to a threshold value which can be arbitrarily set depending on an extent of access restriction so as to generate the comparison result in the third step.

7. The access control method as claimed in claim 1, wherein
a comparison result divided into at least three different stages depending on a degree of the likelihood that the IC card bearer is authentic is generated as the comparison result in the third step.

8. The access control method as claimed in claim 7, wherein
an intermediate value indicating a degree of the likelihood that the IC card bearer is authentic is generated based on the comparison of the biometric information with the previously-obtained biometric information, and the intermediate value is compared to a plurality of threshold values different to each other depending on an extent of access restriction so as to generate comparison results divided into at least three different stages as the comparison result in the third step.

9. IC card comprising:
a non-volatile memory for storing previously-obtained biometric information previously obtained from a bearer of the IC card;
a volatile memory including security status for determining accessibility between the IC card and an external biometric authentication device; and
a CPU, wherein
the CPU comprises:
a transmitter for reading the previously-obtained biometric information from the non-volatile memory and transmitting the read previously-obtained biometric information to the biometric authentication device;
a receiver for receiving a comparison result encrypted by and transmitted from the biometric authentication device, the comparison result being obtained when the biometric authentication device which obtains an IC card bearer's biometric information from the IC card bearer and received the previously-obtained biometric information compares the biometric information with the previously-obtained biometric information; and
an update unit for decoding and verifying the received comparison result and determining whether or not the comparison result is illegally altered or fabricated, the update unit further updating the security status of the volatile memory when it is determined that the comparison result was not illegally altered or fabricated.
